(19) United States
(12) Patent Application Publication
(10) Pub. No.: US 2018/0343220 A1
(43) Pub. Date: Nov. 29, 2018

(54) Providing Notifications with Response Options

(71) Applicant: Microsoft Technology Licensing, LLC, Redmond, WA (US)

(72) Inventor: Adrian AISEMBERG, Sammamish, WA (US)

(21) Appl. No.: 15/605,882

(22) Filed: May 25, 2017

(51) Int. Cl. H04L 12/58

(52) U.S. Cl. CPC H04L 51/18; H04L 51/24

(57) ABSTRACT

A computer-implemented technique is described herein for receiving and responding to a message. In one manner of operation, the technique involves receiving, by a recipient-user, an original message sent by a sender-user. Assume that the sender-user explicitly formulates the original message so that it conforms to a predetermined template. That predetermined template designates a question together with one or more response options. Upon receipt, the technique involves determining whether the original message conforms to the predetermined template. If so, the technique extracts the question and the response option(s) from the original message. The technique then generates a control feature associated with each response option. The technique then displays the question on a user interface presentation of the recipient computing device together with the control feature(s). The recipient-user may respond to the question posed by the original message by selecting an appropriate control feature.

### BACKGROUND

A recipient-user may receive multiple messages sent by sender-users in the course of a single day. In a typical interaction, the recipient-user may receive a notification that informs the recipient-user that an original message has been received. Assume that the sender-user has created the message using a particular application. The recipient-user may click on the notification. This action activates the application, if not already activated. The recipient-user may then interact with the application to reply to the original message, or otherwise interact with the message. While this manner of interaction is ubiquitous, it is cumbersome. It also may have the effect of disrupting whatever task the recipient-user is performing at the time that he or she receives a message.

### SUMMARY

A computer-implemented technique is described herein for receiving and responding to a message. In one manner of operation, the technique involves receiving, by a recipient-user, an original message sent by a sender-user. Assume that the sender-user explicitly formulates the original message so that it conforms to a predetermined template. That predetermined template designates a question together with one or more response options, e.g., in one example, through the use of brackets to enclose the response options.

Upon receipt, the technique involves determining whether the original message conforms to the predetermined template. If so, the technique extracts the question and the response option(s) from the original message. The technique then generates a control feature associated each response option. The technique then displays the question on a user interface presentation of the recipient-user's computing device together with the control feature(s). The recipient-user may respond to the question posed by the original message by selecting an appropriate control feature.

Overall, the technique allows the recipient-user to quickly and easily respond to a sender-user's question. For instance, in some circumstances, the technique does not require the recipient-user to open whatever application has been used to create (and receive) the message. The technique also provides an efficient and unambiguous way for the sender-user to guide the recipient-user's response to the question.

The above technique can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative system which involves sending an original message from a sender computing device to a recipient computing device.

FIG. 2 shows illustrative user interface presentations provided to a sender-user and a recipient-user, respectively, via the sender computing device and the recipient computing device of FIG. 1.

FIG. 3 shows another example of user interface presentations provided to the sender-user and the recipient-user.

FIG. 4 shows one implementation of a message interpretation component, a notification creation component, and a notification interaction component, which are elements of the recipient computing device of FIG. 1.

FIG. 5 shows an illustrative user interface presentation provided by a configuration component, which is another element of the recipient computing device of FIG. 1.

FIG. 6 shows an illustrative process that explains one manner of operation of the recipient computing device of FIG. 1.

FIG. 7 shows illustrative computing functionality that can be used to implement any aspect of the features shown in the foregoing drawings.

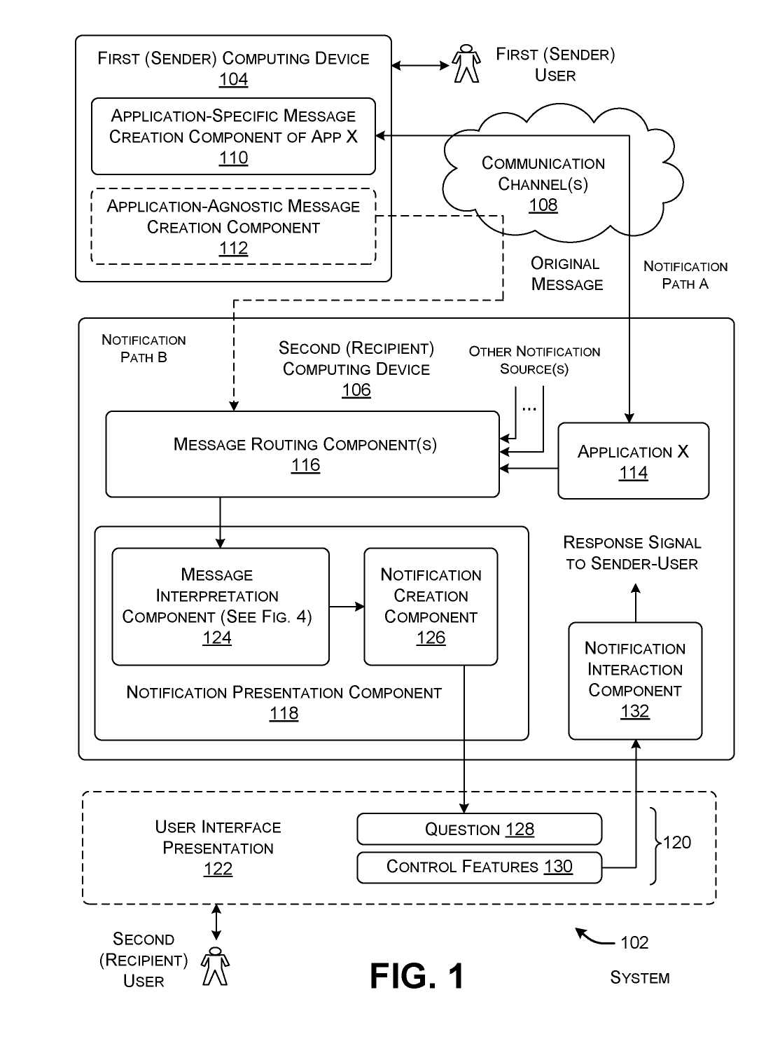

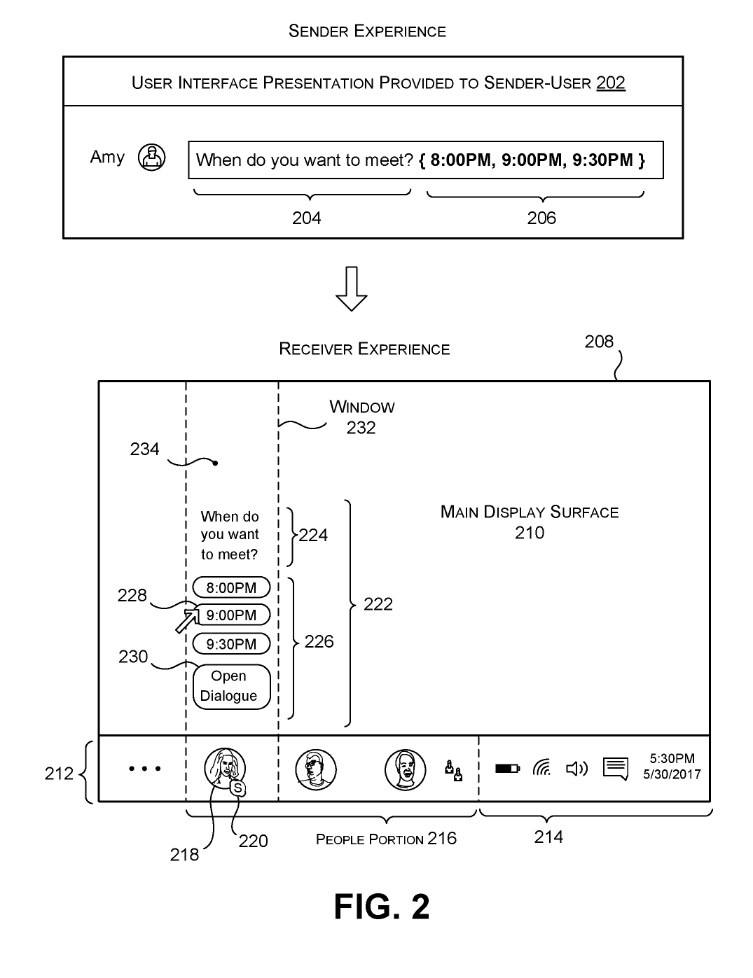

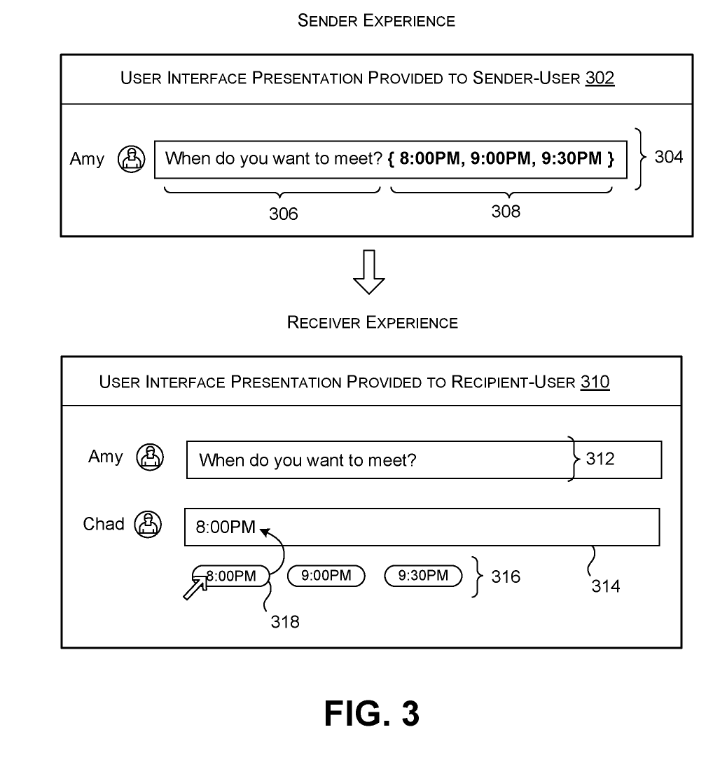

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a computer-implemented system for assisting a recipient-user in responding to an original message. Section B sets forth illustrative methods which explain the operation of the system of Section A. And Section C describes illustrative computing functionality that can be used to implement any aspect of the features described in Sections A and B.

As a preliminary matter, some of the figures describe concepts in the context of one or more structural components, also referred to as functionality, modules, features, elements, etc. In one implementation, the various components shown in the figures can be implemented by software running on computer equipment, or other logic hardware (e.g., FPGAs), etc., or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. Section C provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts can be implemented by software running on computer equipment, or other logic hardware (e.g., FPGAs), etc., or any combination thereof.

As to terminology, the phrase “configured to” encompasses various physical and tangible mechanisms for performing an identified operation. The mechanisms can be configured to perform an operation using, for instance, software running on computer equipment, or other logic hardware (e.g., FPGAs), etc., or any combination thereof.

The term “logic” encompasses various physical and tangible mechanisms for performing a task. For instance, each operation illustrated in the flowcharts corresponds to a logic component for performing that operation. An operation can be performed using, for instance, software running on computer equipment, or other logic hardware (e.g., FPGAs), etc., or any combination thereof. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific terms “computer-readable storage medium” and “computer-readable storage medium device” expressly exclude propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative System

FIG. 1 shows an illustrative system 102 which involves sending an original message from a first (sender) computing device 104 to a second (recipient) computing device 106. More generally, the system 102 can include many more sender computing devices and recipient computing devices, although not shown.

The sender computing device 104 and the recipient computing device 106 can each correspond to any user computing device of any type, including, but not limited to: a stationary desktop computing device, a laptop computing device, any kind of handheld computing device (such as a smartphone or tablet-type computing device), a game console, a set-top box, a wearable computing device, a virtual-reality device, an augmented-reality device, etc., or any combination thereof. The sender computing device 104 interacts with the recipient computing device 106 via one or more communication channels 108, referred to in the singular below for brevity. The communication channel 108 may entail the use of a local area network, a wide area network (e.g., the Internet), one or more point-to-point links, etc., or any combination thereof.

FIG. 1 highlights the features of the sender computing device 104 that play a role in the creation and transmission of the original message. FIG. 1 also shows the features of the recipient computing device 106 that play a role in the receipt and processing of the original message. However, any computing device can function as a sending computing device in some circumstances and a recipient computing device in other circumstances. Thus, although not shown, the sender computing device 104 incorporates all of the features of the recipient computing device 106, and vice versa. Further, certain features described below as being performed by the sender computing device 104 can alternatively, or in addition, be performed by the recipient computing device 106, and vice versa.

As a further clarification, FIG. 1 shows that various components running on a particular computing device are entirely implemented by local functionality resident on that computing device. While this depiction indeed represents one implementation, in other cases, any portion of a local component can be implemented by remote computing functionality, such as a remote computing system (not shown) having one or more servers.

Referring first to the sender computing device 104, the sender-user can create an original message in different ways. In one approach, the sender-user can create the original message using any application, such as a communication-related application or social network-related application, etc. Such an application is referred to generically below as “application X.” In this context, an application-specific message creation component 110 represents whatever functionality that the application X uses to create the message. Alternatively, the sender-user can create the original message using an operating system component. In this context, an application-agnostic message creation component 112 represents whatever functionality that the operating system component uses to create the message. As the name implies, the application-agnostic message creation component 112 creates the message without reliance on any particular application.

In whatever manner that the sender-user creates the original message, the sender-user may produce an original message that designates two parts. A first part corresponds to a question. A second part specifies one or more response options. The response options specify responses that the recipient-user may select in answering the question. In some cases, the first part and the second part correspond to two distinct parts of the original message. In other cases, the second part is embedded in the first part.

Note that any part can be expressed in an explicit or implicit manner. For example, the question may be explicit, e.g., corresponding to a sentence or phrase that ends in a question mark. In other cases, the original message only implies the question. For example, the original message may include an image together with plural response options that represent interpretations of the image. When the image is paired with the response options, the recipient-user will understand that the sender-user is asking the recipient-user to make some judgement with respect to what is depicted in the image.

Further note that a question can be expressed in various ways, and it need not end in a question mark. For example, a sender-user can create an original message that reads: “Choose one of these options: {A, B, C}.” That message asks the user to choose one of three options, but it is phrased as a directive, rather than a question. Hence, the term “question” as used herein has broad connotation. It refers to any expression that invites a response from the recipient-user. A question may be broadly considered as any kind of solicitation that invites a response by the recipient-user.

The sender-user may structure the original message in a manner that conforms to at least one predetermined template. The template defines the manner in which the sender-user is expected to express the first part and the second part. To cite one introductory example, assume that the sender-user wishes to ask the question, “When do you want to meet?” Further assume that the sender-user wishes to invite the recipient-user to select one of three possible response options: 8:00 PM, 9:00 PM, and 9:30 PM. In one merely illustrative case, the sender-user may fashion the original message as: “When do you want to meet? {8:00 PM, 9:00 PM, 9:30 PM}.” The first part of the original message designates the question. The second part of the original message specifies the set of response options. This original message conforms to a predetermined template that requires the user to specify the response options within a pair of predetermined symbols, here corresponding to left and right brackets “{ . . . }.” The template makes the implicit assumption that the part of the original message that is not enclosed by the predetermined symbols corresponds to the question.

Although not shown in the figures, the sender computing device 104 can also include a user-assistance component. The user-assistance component can provide a user interface presentation that assists the user in formulating a message that conforms to a predetermined template, if that is the intent of the sender-user. For instance, the user-assistance component can provide information regarding the available templates that the sender-user may use to structure the original message. The user-assistance component can also optionally inform the sender-user whether the original message that he or she has drafted conforms to any predetermined template. The user-assistance component can also optionally provide a preview to the sender-user which shows the sender-user how the notification will appear to the recipient-user, upon receipt by the recipient-user.

Now referring to the recipient computing device 106, the recipient computing device 106 may operate on the original message using different processing paths, depending on how it is created. In a first case, assume that the sender-user creates the original message using the application-specific message creation component 110, associated with application X. In that case, a counterpart recipient-side application X 114 installed on (or otherwise accessible to) the recipient computing device 106 receives the original message and then forwards it to a message routing component 116. The message routing component 116 then routes the original message to a notification presentation component 118. The notification presentation component 118 generates a notification 120 based on the original message, and displays that notification 120 on a user interface presentation 122.

In a second case, assume that the sender-user creates the original message using the application-agnostic message creation component 112, which, as said, may correspond to an operating system component. In that case, the message routing component 116 may directly receive the original message via an operating system transport mechanism, without involving any application. The message routing component 116 may then forward original notification to the notification presentation component 118.

The notification presentation component 118 includes a message interpretation component 124 and a notification creation component 126. The message interpretation component 124 performs the task of interpreting the original message to determine whether it is constructed in accordance with any predetermined template. If so, the message interpretation component 124 extracts the above-described parts, e.g., corresponding to a question and a set of response options. The notification creation component 126 produces a control feature for each identified response option. For instance, the control feature may correspond to any graphical user interface feature with which the user may interact, such as a button, a checkbox, a slider mechanism, etc. The notification creation component 126 then displays a notification 120 on the user interface presentation 122. The notification 120 includes an extracted question 128 and a set of one or more control features 130. For example, the notification creation component 126 can display the control features 130 below the question 128 on the user interface presentation 122.

Finally, a notification interaction component 132 detects an input signal when (and if) the recipient-user clicks on one of the control features. By doing so, the recipient-user conveys that he or she has selected a corresponding response option. In response, the notification interaction component 132 sends a response signal back to the sender computing device 104 via the communication channel 108. The sender computing device 104 then informs the sender user of the recipient-user's answer to the question.

The notification interaction component 132 can be implemented in various ways. In one case, the application X 114 implements at least part of the notification interaction component 132. In that implementation, the application X 114 performs the task of sending the response signal to a complementary application X provided by the sender computing device 104. In another case, an operating system component implements the notification interaction component 132. In that situation, that operating system component can send the response signal to the sender computing device 104.

Advancing now to FIG. 2, the top portion of that figure shows an illustrative a user interface presentation 202 provided by the sender computing device 104. In this example, the sender-user (a person named Amy) is in the process of interacting with the recipient-user (a person named Chad) via a particular application X. At this point in time, the sender-user enters the original message, “When do you want to meet? {8:00 PM, 9:00 PM, 9:30 PM}.” A first part 204 of the original message corresponds to the question. A second part 206 of the original message corresponds to a set of response options. Here, the sender-user has used a pair of predetermined characters (that is, brackets) to distinguish the response options from the question.

The bottom portion of FIG. 2 shows a user interface presentation 208 provided to the recipient computing device 106. In this merely illustrative case, the user interface presentation 208 may correspond to a home screen provided by the operating system of the recipient computing device 106. For instance, the user interface presentation 202 may represent the graphical desktop of a personal computing device, or the start screen of a mobile computing device (e.g., a smartphone), etc.

The user interface presentation 208 can include a main display surface 210 and at least one task bar 212. The task bar 212 is positioned at the periphery of the main display surface 210, such as at the bottom of the main display surface 210. In other implementations, the task bar 212 appears in another part (or parts) of the user interface presentation 208 with respect to the main display surface 210. In other implementations, the user interface presentation 208 includes some other type(s) of task-related region(s) or graphical control/notification mechanism(s), instead of, or in addition to, a task bar.

The task bar 212 itself includes plural portions dedicated to displaying different kinds of information. A system tray portion 214 uses a set of system icons to convey general information regarding the status of the recipient computing device 106, such as the battery level, network connection status, speaker device status, etc. of the recipient computing device 106. The recipient-user can control various aspects of the recipient computing device 106 by interacting with the system icons shown in the system tray portion 214.

A people portion 216 displays a set of person indicators associated with respective people who have an established relationship with the recipient-user (as defined by the recipient-user). At any time, the recipient-user can interact with the people-portion control component (not shown) to select the set of people. Thereafter, a people-portion (PP) control component (not shown) “pins” person indicators associated with these people to the people portion 216 of the task bar 212. As shown in FIG. 2, each person indicator may include information which identifies a particular person, such as a digital photograph of the particular person, an avatar associated with the particular person, a symbol associated with the particular person, etc.

Generally, the people portion 216 provides a convenient mechanism that allows the recipient-user to interact with individuals associated with the displayed person indicators. For example, the recipient-user can click on any person indicator in the people portion 216. In response, the PP control component can present a control panel to the user. The control panel provides the recipient-user with a set of options for interacting with the selected person, such as by sending a message to that person using the SKYPE application provided by MICROSOFT CORPORATION of Redmond, Wash. In another use scenario, the recipient-user may graphically drag a document in the main display surface 210 to a person indicator. In response, the PP control component can transfer the document to the selected person through a default communication channel (such as via an Email message, SKYPE message, etc.).

As another feature, the notification presentation component 118 displays notifications sent by respective sender-users in proximity to person indicators in the people portion 216 that are associated with those sender-users. For example, in the example of FIG. 2, assume that a person indicator 218 corresponds to the sender-user, the person named Amy. An optional app indicator 220 conveys that the sender-user is using a particular application (here, the SKYPE application) to create and send the original message. The message presentation component 124 displays a notification 222 associated with the original message sent by the sender-user (Amy) immediately above the person indicator 218 associated with that sender-user. Here, the notification 222 includes a first part 224 that specifies a question, and a second part 226 that provides a set of control features. Each control feature, in turn, corresponds to a response option specified in the original message.

The recipient-user may select any response option by selecting its corresponding control feature. In the example of FIG. 2, assume that the recipient-user selects the control feature 228 associated with the response option “9:00 PM” by positioning a mouse cursor over the control feature 228 (using a mouse device) and then clicking on the control feature 228. Alternatively, or in addition, the recipient computing device 106 displays the user interface presentation 208 on a touch-sensitive screen; in that case, the recipient-user may activate the control feature 228 by touching it. Alternatively, or in addition, the recipient computing device 106 provides a voice recognition input mechanism; in that case, the recipient-user may activate the control feature 228 by speaking a specified response option, e.g., by speaking “9:00 PM.” Still other modes of receiving the recipient-user's selection are possible. In whatever manner a control feature is selected, the notification interaction component 132 receives an input signal in response to the sender-user's input action, and then forwards a corresponding response signal to the sender computing device 104.

In some implementations, the notification presentation component 118 can also display an added control feature 230 that invites the user to enter a response option that is not associated with any of the predetermined response options (“8:00 PM,” “9:00 PM,” or “9:30 PM”). In response to activating this control feature 230, the notification interaction component 132 can activate the application X 114 (if not already activated). The recipient-user can then interact with whatever user interface presentation the application X 114 provides to create a custom response to the sender-user's question, e.g., by typing that custom response into an input field provided by the user interface presentation.

Generally, the system 102 is advantageous because it allows the recipient-user to efficiently respond to the original message. For instance, in many cases, the recipient-user may respond to the original message by clicking one of the control features without opening the application X 114. Overall, this user experience reduces the disruption to whatever task the recipient-user is performing at the time that the notification is received.

The system 102 is also advantageous because it provides an efficient and reliable mechanism for controlling the flow of a conversation. For instance, the sender-user can leverage the system 102 to ask a specific question and to train the recipient-user's attention on a specified set of acceptable responses. This feature also assists the recipient-user in understanding how to respond to the question.

FIG. 2 has been explained in the context in which the recipient-user selects a single control feature corresponding to a single response option. But in other cases, the sender-user can frame a question that the recipient-user may answer by clicking on two or more control features. For example, the sender-user can create the directive: “Tell me your two top picks {Yankees, Red Sox, Braves, Astros}.” The recipient-user responds by clicking two control features.

In some implementations, the notification presentation component 118 creates the experience shown in FIG. 2 by presenting a window 232 that has been allocated, in advance, for use in showing notifications associated with the person indicator 218. The window 232 can have any shape, position, dimensions, and behavior. In some implementations, the window 232 corresponds to a ribbon which extends from the person indicator 218 to the top of the user interface presentation 208; that ribbon has a horizontal extent which at least spans the width the person indicator 218. Although not shown, the notification presentation component 118 can allocate other windows to other respective person indicators in the people portion 216. Each such window can take the form of a ribbon which extends up from an associated person indicator to the top of the user interface presentation 208. Generally note that the display surface defined by any such window extends beyond the boundary associated with the task bar 212, thereby accommodating a notification experience which “bleeds” outside the bounds of the task bar 212.

The window 232 presents the notification 222 on a transparent background. The transparent background reveals whatever content is provided on a display surface which lies beneath the window 232. Further, the notification interaction component 132 is configured to pass any clicks (or other actions, such as taps) that the recipient-user directs to the transparent background to a display surface which lies beneath the transparent background. For instance, assume that the notification presentation component 118 detects that the recipient-user clicks on a point 234 in the window 232 that corresponds to part of the transparent background of the window 232 (rather than the notification 222 itself). In response, the notification interaction component 132 can direct the user's input action to whatever display surface lies beneath that point 234, for processing by any event handler associated therewith. In contrast, assume that the notification interaction component 132 detects that the recipient-user clicks on the control feature 228. In response, the notification interaction component 132 can send a response signal indicating the recipient-user's selection of the response option “9:00 PM” to the sender computing device 104.

Other windows can have other dimensions and/or other behaviors compared to window 232 shown in FIG. 2. For example, in another case, the window 232 can have a height dimension that does not reach to the top of the user interface presentation 208. In another case, the window 232 has a width that spans plural person indicators, such that the respective windows associated with different sender-users overlap. Indeed, the notification presentation component 118 can display the content of a notification (associated with a particular sender-user) on a window that encompasses the entire display surface of the user interface presentation 208. This means that the notification presentation component 118 can display notifications for the sender-user anywhere in the user interface presentation 208, while still conveying a graphical nexus between each notification and the sender-user's person indicator (e.g., by showing the notification as emanating from a particular person indicator, and/or as terminating in that person indicator).

In other implementations, the notification presentation component 118 behaves as described above, but the person indicators can appear in any other part(s) of the user interface presentation 202 besides, or in addition to, the task bar 212.

In still other implementations, the notification presentation component 118 can display a notification in such a manner that it conveys an association with a person indicator, but the person indicator no longer has a fixed position within the user interface presentation 208. For example, the notification presentation component 118 can display the notification along with an associated person indicator at any position within the user interface presentation 208, and that position can change over time.

In still other implementations, the notification presentation component 118 can display a notification in a display region associated with the sender of the notification, but without also displaying a person indicator associated with that sender-user. For example, assume that the upper left quadrant of the user interface presentation 208 is associated with a particular sender-user. The recipient-user may interpret a notification that is presented in the upper left quadrant as originating from the particular sender-user, without being explicitly informed of that nexus by the notification presentation component 118. Hence, a “person indicator,” as the term is broadly used herein, can refer to any aspect of the user interface presentation 208 that is associated with a sender-user, not necessarily an explicit icon, picture, avatar, etc.

FIG. 3 shows another example of a user experience provided by the system 102 of FIG. 1. To begin with, the top portion of FIG. 3 shows an illustrative a user interface presentation 302 provided by the sender computing device 104. This sender experience is the same as the sender experience shown in FIG. 2. That is, the sender-user (a person named Amy) interacts with the recipient-user (a person name Chad) via a particular application X. At this point in time, the sender-user enters the same original message 304 shown in FIG. 2, namely, “When do you want to meet? {8:00 PM, 9:00 PM, 9:30 PM}.” Again, a first part 306 of the original message 304 corresponds to the question. A second part 308 of the original message 304 corresponds to a set of response options.

The bottom portion of FIG. 3 shows a user interface presentation 310 provided to the recipient-user, which differs from the recipient experience shown in FIG. 2. In this case, the notification presentation component 118 works in conjunction with the application X 114 to provide the user interface presentation 310. The user interface presentation 310 shows the current state of a dialogue between the sender-user (Amy) and the recipient-user (Chad). In a field 312, the dialogue displays a representation of the question posed by the original message 304. To perform this task, the notification presentation component 118 strips the second part 308 of the original message 304, leaving only the first part 306. It then instructs the application X 114 to display only the first part 306.

The dialogue also includes an input field 314 for receiving the recipient-user's response to the question. Finally, the user interface presentation 310 includes a set of control features 316 associated with the question. The control features 316 represent response options to the question, which, in turn, are extracted from the second part 308 of the original message 304.

In operation, the recipient-user may click on (or otherwise activate) one of the control features 316 to select that corresponding response option. For example, FIG. 3 indicates that the recipient-user selects the control feature 318, corresponding to the response option “8:00 PM.” In response, the notification presentation component 118 (in conjunction with the application X 114) populates the reply “8:00 PM” in the input field 314. The notification interaction component 132 also forwards a corresponding response signal to the sender computing device 104. Alternatively, the recipient-user may draft a custom reply in the input field 314, thereby ignoring the response options specified by the set of control features 316.

In summary, the example of FIG. 3 involves interaction with the application X 114, and therefore does not provide the same level of unobtrusiveness compared to the example of FIG. 2 (which does not necessarily involve activation of the application X 114). Nevertheless, the example of FIG. 3 still provides good user experience by assisting the recipient-user in replying to the sender-user's question. And the example of FIG. 3 continues to provide a mechanism by which the sender-user can control the flow of the dialogue in an unambiguous manner by explicitly suggesting reply options.

FIGS. 2 and 3 are to be interpreted in the spirit of illustration and not limitation. Other implementations can use yet other user interface presentations to interact with the system 102 of FIG. 1.

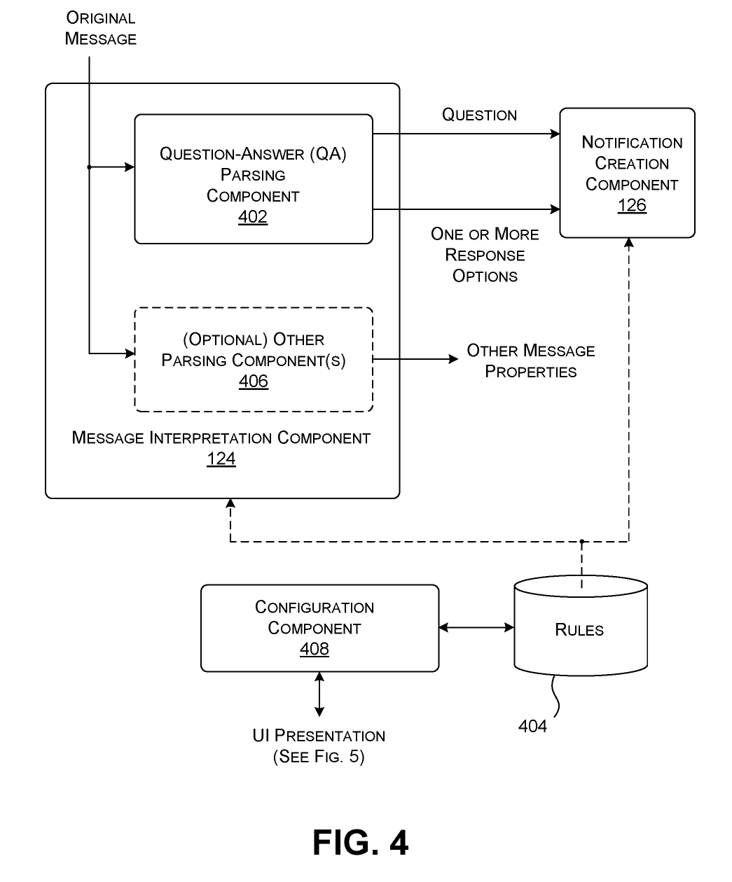

Advancing to FIG. 4, this figure shows one implementation of the notification presentation component 118, including the message interpretation component 124 and the notification creation component 126. By way of overview, the message interpretation component 124 interprets the original message sent by the sender-user. It provides output information to the notification creation component 126. The output information reflects the results of its interpretation of the original message. The notification creation component 126 then creates a notification based on the output information.

More specifically, the message interpretation component 124 includes a question-answer parsing component (“QA parsing component”) 402 for use in identifying the question and response option(s) (if any) posed by the original message. The QA parsing component 402 performs its analysis based on one or more rules provided in a data store 404.

For example, in applying one kind of illustrative rule, the QA parsing component 402 can determine whether the original message includes one or more predetermined characters, where those characters are used to demarcate the presence of response options. If the special character(s) are present, the QA parsing component 402 can extract the response options demarcated by the characters. The parsing component 402 can designate the remaining portion of the original message as the question.

More specifically, consider a first illustrative rule that specifies that the response options (if present in the original message) will be enclosed in brackets. That rule may further specify that original message separates distinct response options with commas, as shown in the examples of FIGS. 2 and 3. Based on this rule, the QA parsing component 402 identifies a pair of brackets and extracts the text enclosed therein. The QA parsing component 402 then enumerates the separate response options based on the presence of commas within the extracted text. Overall, the first rule corresponds to an example in which the question and the response option(s) appear in two distinct and non-overlapping parts of the original message.

Next consider a second rule that specifies that the response options will be demarcated within the body of the original question using special characters, as in the example, “Do you want meet at <8:00 PM>, <9:00 PM>, or <9:30 PM>?” Based on this rule, the QA parsing component 402 extracts each phrase enclosed by a pair of complementary angel brackets, and identifies that phrase as a response option. A second optional part of the rule may contain an instruction that directs the notification creation component 126 to strip the special characters (e.g., angel brackets) from the original message before presenting the question to the user interface presentation 122. Overall, the second rule describes a case in which the response options are embedded in the question posed by the original message.

A third kind of rule may identify response options in an original message based on the structure and/or phrasing of the original message, without the use of special characters. For example, consider a question that includes response options separated by the word “or.” A rule can specify that the words (or phrases) that occur on the left and right of the word “or” correspond to response options. In another case, a rule can specify that any question which begins with “Do you,” “Are you,” “Can you,” etc. implicitly designates the binary response options of “Yes” and “No.” This reflects a default assumption, irrespective of whether the question itself contains the words “yes” and “no.”

The above-described rules are set forth in the spirit of illustration, not limitation. Other implementations can work in conjunction with yet other types of rules.

The message interpretation component 124 may optionally include one or more additional types of parsing components 406. Each such other parsing component extracts control information from the original message, where that control information is not necessarily related to the answer-response structure of the original message. The notification creation component 126 responds to the control information by controlling some aspect of the resultant notification, not necessarily related to the manner in which the notification presents a question and associated response options.

For example, without limitation, a sender-user can include control information in the original message that specifies any of: a location at which a notification is to be presented in a user interface presentation; a timing at which the notification is to be presented; a timing at which the notification is to be removed after presentation; a visual characteristic of the notification when displayed; a priority level of the notification; a behavior of the notification when activated by the recipient-user, and so on. The message interpretation component 124 can use parsing components that are dedicated to extracting respective instances of control information. For example, an optional parsing component can determine whether the original message includes control information which specifies the timing at which the notification is to be presented. Another optional parsing component can determine whether the original message includes control information which specifies the timing at which the notification is to be removed after presentation, and so on.

To cite merely one example, the sender-user can fashion an original message that reads, “When do you want to meet? * 1 hr *.” A parsing component can identify the presence of the control information (“1 hr”) enclosed by pairs of special characters (e.g., “*” symbols). The parsing component interprets the control information as an instruction to present a notification for the message no later than one hour from a current point in time. Hence, if the recipient-user logs onto the recipient computing device 106 more than one hour after the message is sent, he or she will not be presented with the notification.

The notification presentation component 118 may optionally include a configuration component 408. The configuration component 408 enables an end user (or anyone else) to create custom rules for storage in the data store 404. Alternatively, or in addition, the data store 404 includes predetermined rules created by a developer.

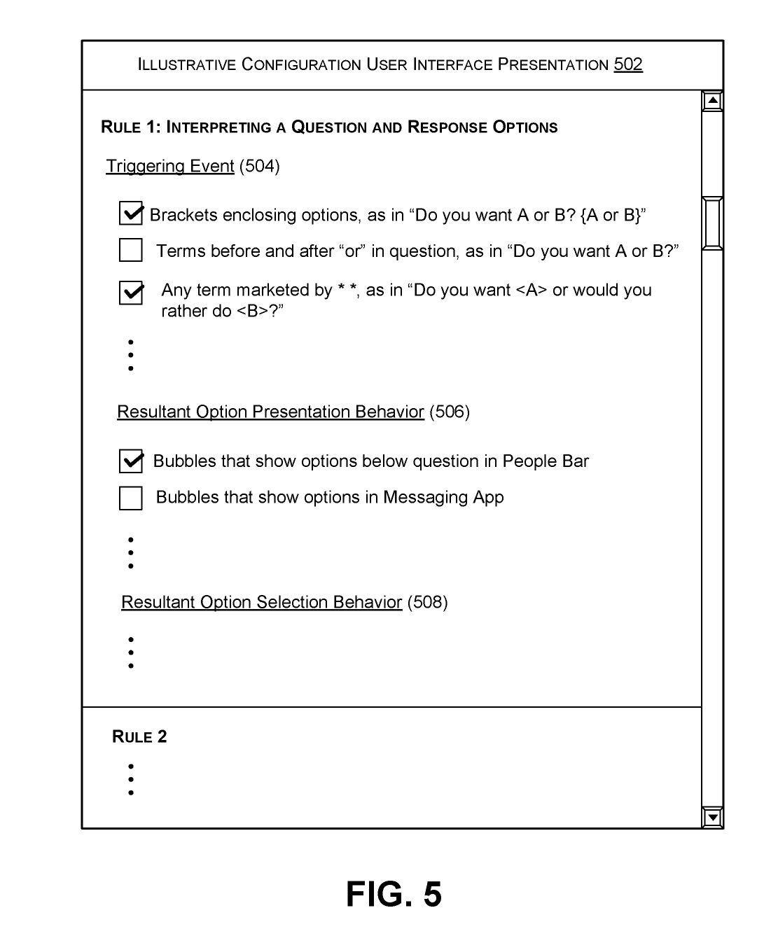

FIG. 5 shows an illustrative configuration user interface presentation 502 provided by the configuration component 408. The configuration user interface presentation 502 allows an end user (or anyone else) to create one or more rules for storage in the data store 404. Each rule guides the recipient computing device 106 in interpreting an original message and then acting on that interpretation. For instance, the Rule 1 shown in FIG. 5 is devoted to processing an original message to identify the question it contains (if any) and the response options it contains (if any).

A rule can include multiple parts. A first part 504 defines a manner in which the message interpretation component 124 will interpret the original message. A second part 506 defines a manner in which the notification creation component 126 will create the notification in response to the interpretation provided by the message interpretation component 124. A third part 508 specifies the behavior of the notification interaction component 132 when a recipient-user interacts with a notification.

B. Illustrative Processes

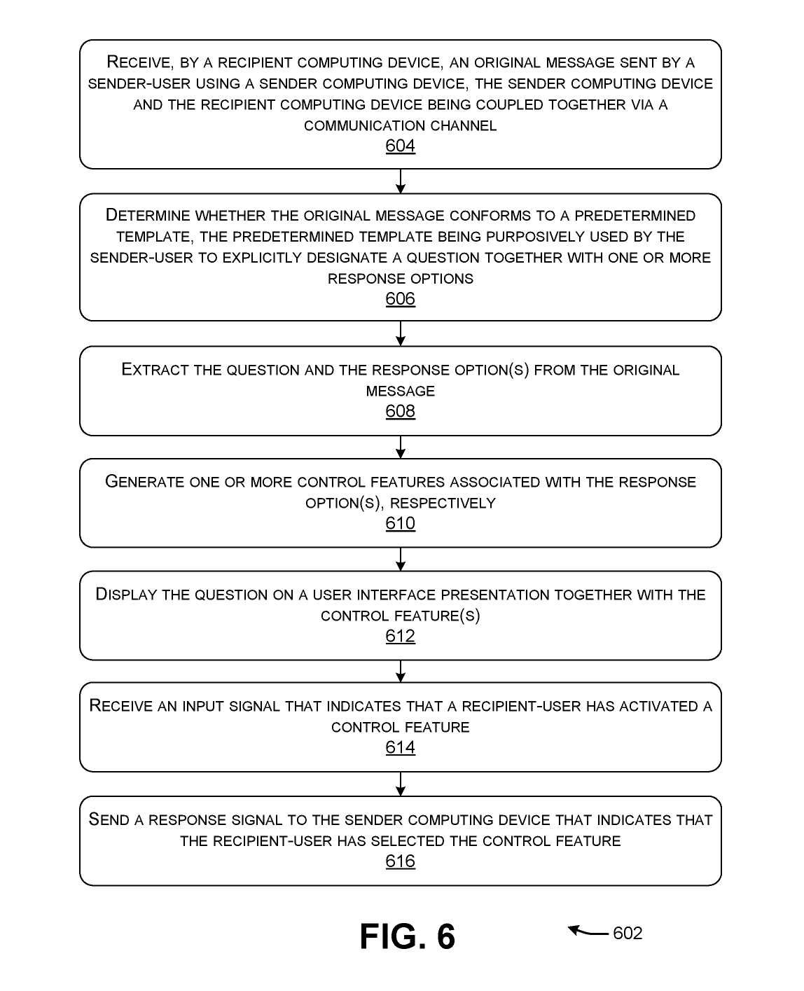

FIG. 6 shows a process 602 that explains the operation of the system 102 of Section A in flowchart form. Since the principles underlying the operation of the system 102 have already been described in Section A, certain operations will be addressed in summary fashion in this section. As noted in the prefatory part of the Detailed Description, the flowchart is expressed as a series of operations performed in a particular order. But the order of these operations is merely representative, and can be varied in any manner.

In block 604, the recipient computing device 106 receives an original message sent by a sender-user using a sender computing device 104 (wherein the sender computing device 104 and the recipient computing device 106 are coupled together via a communication channel 108). In block 606, the recipient computing device 106 determines whether the original message conforms to a predetermined template. That predetermined template is used by the sender-user to purposively designate a question together with one or more response options, where the question broadly refers to any solicitation of a response from the recipient-user. Assume that the original message does indeed conform to a template. In block 608, the recipient computing device 106 extracts the question and the response option(s) from the original message. In block 610, the recipient computing device 106 generates a control feature associated with each response option. In block 612, the recipient computing device 106 displays the question 128 on a user interface presentation 122 together with the control feature(s) 130. In block 614, the recipient computing device 106 receives an input signal that indicates that a recipient-user has activated a control feature, corresponding to an activated control feature. And in block 616, the recipient computing device 106 sends a response signal to the sender computing device 104 that indicates that the recipient-user has selected the control feature.

C. Representative Computing Functionality

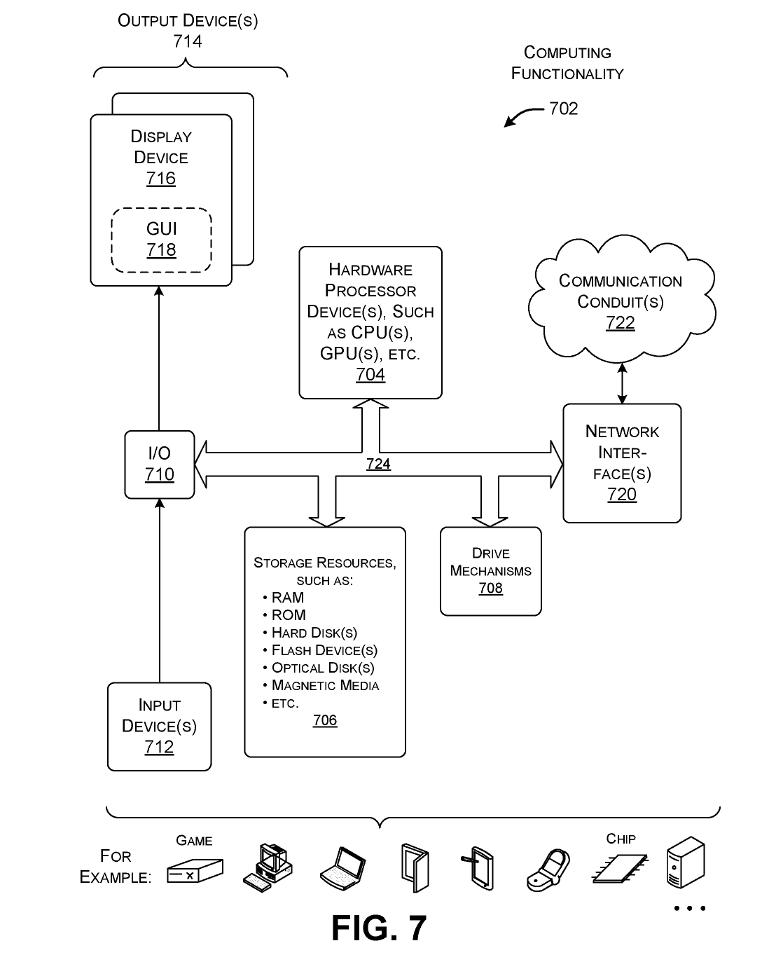

FIG. 7 shows computing functionality 702 that can be used to implement any aspect of the mechanisms set forth in the above-described figures. For instance, the type of computing functionality 702 shown in FIG. 7 can be used to implement the sender computing device 104 or the recipient computing device 106. In all cases, the computing functionality 702 represents one or more physical and tangible processing mechanisms.

The computing functionality 702 can include one or more hardware processor devices 704, such as one or more central processing units (CPUs), and/or one or more graphics processing units (GPUs), and so on. The computing functionality 702 can also include any storage resources (also referred to as computer-readable storage media or computer-readable storage medium devices) 706 for storing any kind of information, such as machine-readable instructions, settings, data, etc. Without limitation, for instance, the storage resources 706 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 702. The computing functionality 702 may perform any of the functions described above when the hardware processor device(s) 704 carry out computer-readable instructions stored in any storage resource or combination of storage resources. For instance, the computing functionality 702 may carry out computer-readable instructions to perform each block of the process 602 described in Section B. The computing functionality 702 also includes one or more drive mechanisms 708 for interacting with any storage resource, such as a hard disk drive mechanism, an optical disk drive mechanism, and so on.

The computing functionality 702 also includes an input/output component 710 for receiving various inputs (via input devices 712), and for providing various outputs (via output devices 714). Illustrative input devices include a keyboard device, a mouse input device, a touchscreen input device, a digitizing pad, one or more static image cameras, one or more video cameras, one or more depth camera systems, one or more microphones, a voice recognition mechanism, any movement detection mechanisms (e.g., accelerometers, gyroscopes, etc.), and so on. One particular output mechanism may include a display device 716 and an associated graphical user interface presentation (GUI) 718. The display device 716 may correspond to a liquid crystal display device, a cathode ray tube device, a projection mechanism, etc. The display device 716 can be used, for instance, to present the user interface presentations shown in FIGS. 2 and 3. Other output devices include a printer, one or more speakers, a haptic output mechanism, an archival mechanism (for storing output information), and so on. The computing functionality 702 can also include one or more network interfaces 720 for exchanging data with other devices via one or more communication conduits 722. One or more communication buses 724 communicatively couple the above-described components together.

The communication conduit(s) 722 can be implemented in any manner, e.g., by a local area computer network, a wide area computer network (e.g., the Internet), point-to-point connections, etc., or any combination thereof. The communication conduit(s) 722 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 702 (and its hardware processor) can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc. In this case, the machine-executable instructions are embodied in the hardware logic itself.

The following summary provides a non-exhaustive list of illustrative aspects of the technology set forth herein.

According to a first aspect, a method is described for receiving and responding to a message. The method includes receiving, by a recipient computing device, an original message sent by a sender-user using a sender computing device, the sender computing device and the recipient computing device being coupled together via a communication channel. The method also includes determining whether the original message conforms to a predetermined template, the predetermined template being purposively used by the sender-user to designate a question together with one or more response options. When the original message conforms to the predetermined template, the method includes: extracting the question from the original message; extracting the response option(s) from the original message; generating one or more control features associated with the response option(s), respectively; displaying the question on a user interface presentation on a display device of the recipient computing device, together with the control feature(s); receiving an input signal that indicates that a recipient-user has activated a control feature, corresponding to one of the control feature(s); and sending a response signal to the sender computing device that indicates that the recipient-user has selected the control feature.

According to a second aspect, the predetermined template designates the response option(s) using at least one predetermined character.

According to a third aspect, the predetermined character(s) corresponds to at least one pair of brackets.

According to a fourth aspect, the predetermined template designates the response option(s) using a predetermined phrasing structure.

According to a fifth aspect, the method further includes, in a preliminary configuration operation: creating a rule in a data store that specifies the predetermined template; and storing the rule in a data store.

According to a sixth aspect, the user interface presentation includes portions associated with different respective sender-users. Further, the operation of displaying involves displaying the question and the control feature(s) in positional association with a portion of the user interface presentation associated with the sender-user who sent the original message.

According to a seventh aspect, the original message is created by the sender-user using a particular application.

According to an eighth aspect, the displaying operation involves displaying the question and the control feature(s) without opening the particular application. Further, the operation of receiving the input signal involves receiving the input signal also without opening the particular application.

According to a ninth aspect, the method further includes displaying another control feature which invites the recipient-user to open the particular application.

According to a tenth aspect, the displaying operation is alternatively performed by the particular application.

According to an eleventh aspect, the method also includes determining whether the original message conforms to another predetermined template, the other predetermined template being used by the sender-user to explicitly designate a visual characteristic of the question and/or the control feature(s), when displayed on the user interface presentation.

According to a twelfth aspect, the method also includes determining whether the original message conforms to another predetermined template, the other predetermined template being used by the sender-user to explicitly designate a timing at which the question and the control feature(s) are displayed on the user interface presentation and/or removed from the user interface presentation.

According to a thirteenth aspect, a recipient computing device is described. The recipient computing device includes a message routing component configured to receive an original message sent by a sender-user using a sender computing device, the sender computing device and the recipient computing device being coupled together via a communication channel. The recipient computing device also includes a question-answer parsing component configured to: determine whether the original message conforms to a predetermined template, the predetermined template being used by the sender-user to purposively designate a question together with one or more response options; and when the original message conforms to the predetermined template, extract the question and the response option(s) from the original message. The recipient computing device also includes a notification creation component configured to: generate one or more control features associated with the response option(s), respectively; and display the question on a user interface presentation on a display device of the recipient computing device, together with the control feature(s). The recipient computing device also includes notification interaction component configured to: receive an input signal that indicates that a recipient-user has activated a control feature, corresponding to one of the control feature(s); and send a response signal to the sender computing device that indicates that the recipient-user has selected the control feature.

According to a fourteenth aspect (depending from the thirteenth aspect), the predetermined template designates the response option(s) using at least one predetermined character.

According to a fifteenth aspect (depending from the fourteenth aspect), the predetermined character(s) includes at least one pair of brackets.

According to a sixteenth aspect (depending from the thirteenth aspect), the recipient computing device further includes a configuration component that is configured to, in a preliminary configuration operation, create a rule that specifies the predetermined template, and store the rule in a data store.

According to a seventeenth aspect (depending from the thirteenth aspect), the user interface presentation includes portions associated with different respective sender-users, and wherein the notification creation component is configured to display the question and the control feature(s) in positional association with a portion of the user interface associated with the sender-user who sent the original message.

According to an eighteenth aspect (depending from the thirteenth aspect), the original message is created by the sender-user using a particular application. Further, the notification creation component is configured to display the question and the control feature(s) without opening the particular application, and the notification interaction component is also configured to receive the input signal without opening the particular application.

According to a nineteenth aspect, a computer-readable storage medium is described for storing computer-readable instructions. The computer-readable instructions, when executed by one or more processor devices, perform a method that includes receiving, by a recipient computing device, an original message sent by a sender-user using a sender computing device, wherein the sender computing device and the recipient computing device are coupled together via a communication channel. The method also includes determining whether the original message includes one or more characters that the sender-user has used to purposively demarcate one or more response options. When the original message includes the character(s), the method further includes: extracting the response option(s) from the original message based on the character(s); extracting a question from the original message; generating one or more control features associated with the response option(s), respectively; displaying the question on a user interface presentation of a display device, together with the control feature(s); receiving an input signal that indicates that a recipient-user has activated a control feature, corresponding to one of the control feature(s); and sending a response signal to the sender computing device that indicates that the recipient-user has selected the control feature. The operation of displaying and receiving of the input signal are performed without opening an application associated with the original message.

According to a twentieth aspect (depending from the nineteenth aspect), the character(s) correspond to at least one pair of brackets.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for receiving and responding to a message, comprising:
receiving, by a recipient computing device, an original message sent by a sender-user using a sender computing device, the sender computing device and the recipient computing device being coupled together via a communication channel;
determining whether the original message conforms to a predetermined template, the predetermined template being purposively used by the sender-user to designate a question together with one or more response options; and
when the original message conforms to the predetermined template:
extracting the question from the original message;
extracting said one or more response options from the original message;
generating one or more control features associated with said one or more response options, respectively;
displaying the question on a user interface presentation on a display device of the recipient computing device, together with said one or more control features;
receiving an input signal that indicates that a recipient-user has activated a control feature, corresponding to one of said one or more control features; and
sending a response signal to the sender computing device that indicates that the recipient-user has selected the control feature.

2. The method of claim 1, wherein the predetermined template designates said one or more response options using at least one predetermined character.

3. The method of claim 2, wherein said at least one predetermined character corresponds to at least one pair of brackets.

4. The method of claim 1, wherein the predetermined template designates said one or more response options using a predetermined phrasing structure.

5. The method of claim 1, further comprising, in a preliminary configuration operation:
creating a rule in a data store that specifies the predetermined template; and
storing the rule in a data store.

6. The method of claim 1, wherein the user interface presentation includes portions associated with different respective sender-users, and wherein said displaying involves displaying the question and said one or more control features in positional association with a portion of the user interface presentation associated with the sender-user who sent the original message.

7. The method of claim 1, wherein the original message is created by the sender-user using a particular application.

8. The method of claim 7,
wherein said displaying involves displaying the question and said one or more control features without opening the particular application, and
wherein said receiving of the input signal involves receiving the input signal also without opening the particular application.

9. The method of claim 8, further comprising displaying another control feature which invites the recipient-user to open the particular application.

10. The method of claim 7, wherein said displaying is performed by the particular application.

11. The method of claim 1, further including also determining whether the original message conforms to another predetermined template, the other predetermined template being used by the sender-user to explicitly designate a visual characteristic of the question and/or said one or more control features, when displayed on the user interface presentation.

12. The method of claim 1, further including also determining whether the original message conforms to another predetermined template, the other predetermined template being used by the sender-user to explicitly designate a timing at which the question and said one or more control features are displayed on the user interface presentation and/or removed from the user interface presentation.

13. A recipient computing device, comprising:
a message routing component configured to receive an original message sent by a sender-user using a sender computing device, the sender computing device and the recipient computing device being coupled together via a communication channel;
a question-answer parsing component configured to:
determine whether the original message conforms to a predetermined template, the predetermined template being used by the sender-user to purposively designate a question together with one or more response options; and
when the original message conforms to the predetermined template, extract the question and said one or more response options from the original message;
a notification creation component configured to:
generate one or more control features associated with said one or more response options, respectively; and
display the question on a user interface presentation on a display device of the recipient computing device, together with said one or more control features; and
a notification interaction component configured to:
receive an input signal that indicates that a recipient-user has activated a control feature, corresponding to one of said one or more control features; and
send a response signal to the sender computing device that indicates that the recipient-user has selected the control feature.

14. The recipient computing device of claim 13, wherein the predetermined template designates said one or more response options using at least one predetermined character.

15. The recipient computing device of claim 14, wherein said at least one predetermined character includes at least one pair of brackets.

16. The recipient computing device of claim 13, further comprising a configuration component that is configured to, in a preliminary configuration operation, create a rule that specifies the predetermined template, and store the rule in a data store.

17. The recipient computing device of claim 13, wherein the user interface presentation includes portions associated with different respective sender-users, and wherein the notification creation component is configured to display the question and said one or more control features in positional association with a portion of the user interface associated with the sender-user who sent the original message.

18. The recipient computing device of claim 13,
wherein the original message is created by the sender-user using a particular application,
wherein the notification creation component is configured to display the question and said one or more control features without opening the particular application, and
wherein the notification interaction component is also configured to receive the input signal without opening the particular application.

19. A computer-readable storage medium for storing computer-readable instructions, the computer-readable instructions, when executed by one or more processor devices, performing a method that comprises:
receiving, by a recipient computing device, an original message sent by a sender-user using a sender computing device,
the sender computing device and the recipient computing device being coupled together via a communication channel;
determining whether the original message includes one or more characters that the sender-user has used to purposively demarcate one or more response options; and
when the original message includes said one or more characters:
extracting said one or more response options from the original message based on said one or more characters;
extracting a question from the original message;
generating one or more control features associated with said one or more response options, respectively;
displaying the question on a user interface presentation on a display device, together with said one or more control features;
receiving an input signal that indicates that a recipient-user has activated a control feature, corresponding to one of said one or more control features; and
sending a response signal to the sender computing device that indicates that the recipient-user has selected the control feature,
said displaying and receiving of the input signal being performed without opening an application associated with the original message.

20. The computer-readable storage medium of claim 19, wherein said one or more characters correspond to at least one pair of brackets.
